(19) United States
(12) Patent Application Publication
(10) Pub. No.: US 2025/0157256 A1
(43) Pub. Date: May 15, 2025

(54) MONITORING APPARATUS, MONITORING METHOD, AND NON-TRANSITORY COMPUTER-READABLE MEDIUM

(71) Applicant: NEC Corporation, Minato- ku, Tokyo (JP)

(72) Inventors: Noboru YOSHIDA, Tokyo (JP); Satoshi YAMAZAKI, Tokyo (JP); Jianquan LIU, Tokyo (JP); Tingting DONG, Tokyo (JP); Karen STEPHEN, Tokyo (JP); Youhei SASAKI, Tokyo (JP); Yuta NAMIKI, Tokyo (JP); Naoki SHINDOU, Tokyo (JP)

(73) Assignee: NEC Corporation, Minato- ku, Tokyo (JP)

(21) Appl. No.: 18/833,057

(22) PCT Filed: Feb. 10, 2022
(86) PCT No.: PCT/JP2022/005413

§ 371 Date: Jul. 25, 2024

(51) Int. Cl. G06V 40/20; G06T 7/70

(52) U.S. Cl. CPC G06V 40/20; G06T 7/70

(57) ABSTRACT

A monitoring apparatus (102) includes a detection unit (103) that detects a person P taking a predetermined action, based on an image being acquired by imaging an inspection area R, and an output unit (104) that outputs detection information relating to the person P being detected. For example, the predetermined action includes at least one of a first action being decided in relation to an item, a second action being decided in relation to a visual line of a person, a third action being decided in relation to a movement (including staying) of a person, a fourth action being decided in relation to entry in/exit from a predetermined area, and the like.

### TECHNICAL FIELD

The present invention relates to a monitoring apparatus, a monitoring system, a monitoring method, and a program.

### BACKGROUND ART

A processing apparatus described in Patent Document 1 includes an image analysis means, a registration management means, and a change decision means. The image analysis means extracts a plurality of types of feature values of a person being detected from an image. The registration management means decides, based on the feature values being extracted, whether data relating to the person being detected is stored in a storage unit storing a feature value of each of a plurality of persons. When it is decided that the data relating to the person being detected are stored, the change decision means decides presence of absence of a change in external appearance of the person being detected, based on the feature value being stored in the storage unit and the feature value being extracted.

An image retrieving apparatus described in Patent Document 2 includes a pose estimation unit, a feature value extraction unit, an image database, a query generation unit, and an image retrieving unit. The pose estimation unit recognizes, from an input image, pose information that includes a plurality of keypoints and relates to a retrieval target. The feature value extraction unit extracts a feature value from the pose information and the input image. The image database accumulates the feature value in association with the input image. The query generation unit generates a retrieval query from the pose information being specified by a user. The image retrieving unit retrieves, from the image database, an image including a similar pose according to the retrieval query.

A video monitoring apparatus described in Patent Document 3 includes a photographing unit, a video processing unit, a gaze feature computation unit, an information recording unit, and a report unit. The video processing unit detects a person from an image being photographed by the photographing unit, and extracts visual line direction information relating to the person. The gaze feature computation unit computes a gaze feature value from the visual line direction information relating to each person. The information recording unit records the image being acquired from the photographing unit, the visual line direction information relating to each person, and the gaze feature value. The report unit acquires, from the gaze feature value being recorded in the information recording unit, information relating to an action of the person being photographed, and reports the acquired information.

Patent Document 4 describes that, in an immigration inspection area, a stress index of an entrant is computed from biometric data being detected by a biometric sensor, and the entrant is estimated as a suspicious person when the stress index is higher than a predetermined reference value. Further, it is described that, as biometric data, vital data such as a brain wave, a cerebral blood flow, a pulse wave, blood pressure, a respiratory rate, a body temperature, and a sweat volume may be employed

### RELATED DOCUMENT

### Patent Document

Patent Document 1: Japanese Patent Application Publication No. 2020-160883
Patent Document 2: Japanese Patent Application Publication No. 2019-091138
Patent Document 3: Japanese Patent Application Publication No. 2007-006427
Patent Document 4: Japanese Patent Application Publication No. 2018-037075

### DISCLOSURE OF THE INVENTION

### Technical Problem

In general, an inspection area such as the customs is one of places that require particular vigilance for preventing an illegal activity. Meanwhile, an inspection area is one of places where monitoring is difficult to perform due to frequent congestion caused by arrival and departure of flights and the large number of persons carrying large luggage.

However, Patent Documents 1 to 3 do not disclose a technique for monitoring an inspection area. Thus, there may be a risk that monitoring in an inspection area cannot be assisted effectively by the techniques described in Patent Documents 1 to 3.

In Patent Document 4, in a case in which a stress index being computed from biometric data relating to an entrant is equal to or less than a predetermined reference value, there is a risk that, even when the entrant is a suspicious person who requires an enforcement action or the like, it may not be detected. Thus, even when the technique described in Patent Document 4 is applied, there may be a risk that monitoring in an inspection area cannot be assisted effectively.

In view of the above-mentioned problem, one example of an object of the present invention it to provide a monitoring apparatus, a monitoring system, a monitoring method, and a program that solve a risk that monitoring in an inspection area cannot be assisted effectively.

### Solution to Problem

According to one aspect of the present invention, there is provided a monitoring apparatus including:
a detection unit that detects a person taking a predetermined action, based on an image being acquired by imaging an inspection area; and
an output unit that outputs detection information relating to the person being detected.

According to one aspect of the present invention, there is provided a monitoring system including:
the monitoring apparatus described above; and
an imaging apparatus that generates image information including an image of the inspection area according to imaging the inspection area.

According to one aspect of the present invention, there is provided a monitoring method including,
by a computer:
   detecting a person taking a predetermined action, based on an image being acquired by imaging an inspection area; and
   outputting detection information relating to the person being detected.

According to one aspect of the present invention, there is provided a program for causing a computer to execute:
detecting a person taking a predetermined action, based on an image being acquired by imaging an inspection area; and
outputting detection information relating to the person being detected.

### Advantageous Effects of Invention

According to the present invention, it is possible to assist monitoring in an inspection area effectively.

### BRIEF DESCRIPTION OF THE DRAWINGS

FIG. 1 is a diagram illustrating an overview of a monitoring system according to a first example embodiment of the present invention.

FIG. 2 is a flowchart illustrating an overview of monitoring processing according to the first example embodiment of the present invention.

FIG. 3 is a diagram illustrating a configuration example of the monitoring system according to the first example embodiment while providing a diagram of one example of an inspection area viewed from above.

FIG. 4 is a diagram illustrating a functional configuration example of a detection unit according to the first example embodiment.

FIG. 5 is a diagram illustrating a physical configuration example of a monitoring apparatus according to the first example embodiment of the present invention.

FIG. 6 is a flowchart illustrating a detailed example of detection processing according to the first example embodiment.

FIG. 7 is a flowchart illustrating a detailed example of output processing according to the first example embodiment.

FIG. 8 is a diagram illustrating one example of a configuration of detection information.

FIG. 9 is a diagram illustrating one example of the detection information being displayed by a display unit.

FIG. 10 is a diagram illustrating a configuration example of a monitoring system according to a second modification example.

FIG. 11 is a diagram illustrating a configuration example of a monitoring system according to a second example embodiment of the present invention.

FIG. 12 is a diagram illustrating a functional configuration example of a detection unit according to the second example embodiment.

FIG. 13 is a flowchart illustrating one example of detection processing according to the second example embodiment.

FIG. 14 is a diagram illustrating a configuration example of a monitoring system according to a third example embodiment of the present invention.

FIG. 15 is a diagram illustrating a functional configuration example of a detection unit according to the third example embodiment.

FIG. 16 is a flowchart illustrating one example of detection processing according to the third example embodiment.

### EXAMPLE EMBODIMENT

Example embodiments of the present invention are described below with reference to the drawings. Note that, in all the drawings, a similar constituent element is denoted with a similar reference sign, and description therefor is omitted appropriately.

### First Example Embodiment

### (Overview)

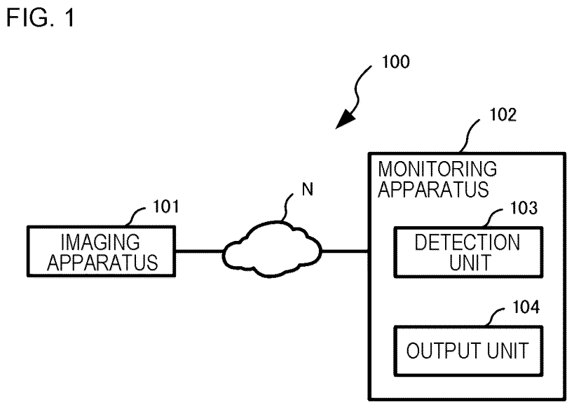

FIG. 1 is a diagram illustrating an overview of a monitoring system 100 according to a first example embodiment of the present invention.

The monitoring system 100 includes an imaging apparatus 101 and a monitoring apparatus 102.

The imaging apparatus 101 generates image information including an image of an inspection area according to imaging the inspection area.

The monitoring apparatus 102 includes a detection unit 103 and an output unit 104.

The detection unit 103 detects a person taking a predetermined action, based on an image being acquired by imaging the inspection area. The output unit 104 outputs detection information relating to the person being detected.

According to the monitoring system 100, it is possible to assist monitoring in an inspection area effectively. According to the monitoring method, it is possible to assist monitoring in an inspection area effectively.

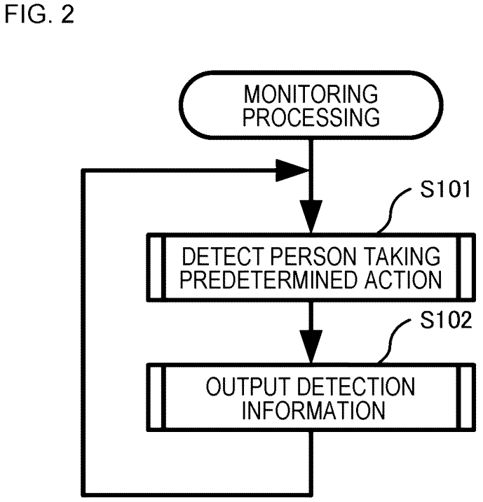

FIG. 2 is a flowchart illustrating an overview of monitoring processing according to the first example embodiment of the present invention.

The detection unit 103 detects a person taking a predetermined action, based on an image being acquired by imaging an inspection area (step S101). The output unit 104 outputs detection information relating to the person being detected (step S102).

According to the monitoring processing, it is possible to assist monitoring in an inspection area effectively.

A detailed example of the monitoring system according to the first example embodiment is described below.

### (Details)

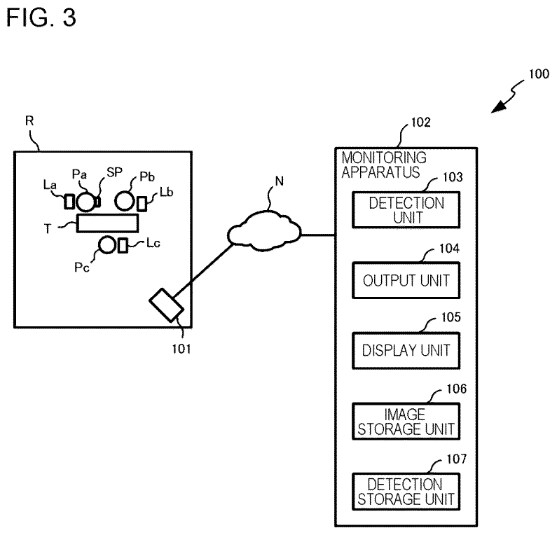

FIG. 3 is a diagram illustrating a configuration example of the monitoring system 100 according to the first example embodiment while providing a diagram of one example of an inspection area R viewed from above. The monitoring system 100 is a system for monitoring the inspection area R.

For example, the inspection area R is an inspection area of the customs. FIG. 3 illustrates a state in which three persons Pa, Pb, and Pc are present in a periphery of a writing stand T provided in the inspection area R. Near the persons Pa, Pb, and Pc, luggage La, Lb, and Lc belonging thereto, respectively, are present. Near the person Pa, a smartphone SP is present.

Hereinafter, when the persons Pa, Pb, and Pc are not particularly discriminated from one another, any one of the persons Pa, Pb, and Pc is also referred to as a “person P”. In other words, the “person P” is a person present in the inspection area R. When the luggage La, Lb, and Lc are not particularly discriminated from one another, any one piece of the luggage La, Lb, and Lc is also referred to as “luggage L”. In other words, the “luggage L” is luggage present in the inspection area R.

As described above, the monitoring system 100 includes the imaging apparatus 101 and the monitoring apparatus 102.

The imaging apparatus 101 and the monitoring apparatus 102 are connected to each other via a network N. The network N is a communication network being wired, wireless, or configured by a combination thereof. Thus, the imaging apparatus 101 and the monitoring apparatus 102 are capable of transmitting and receiving information, data, and the like mutually via the network N.

The imaging apparatus 101 is an apparatus for imaging the inspection area R. The imaging apparatus 101 is a camera or the like. The imaging apparatus 101 images the inspection area R. The imaging apparatus 101 generates image information including an image being acquired by imaging the inspection area R, according to imaging the inspection area R. The imaging apparatus 101 transmits the image information to the monitoring apparatus 102 via the network N.

The imaging apparatus 101 may perform imaging successively. In this case, the imaging apparatus 101 may transmit the image information including a video (moving image) consisting of a plurality of images to the monitoring apparatus 102 in real time.

It is preferred that the imaging apparatus 101 images the entire inspection area R. The monitoring system 100 may include a plurality of imaging apparatuses 101 in order to image the entire inspection area R.

### (Functional Configuration of Monitoring Apparatus 102)

The monitoring apparatus 102 is an apparatus for monitoring the inspection area R. In detail, the monitoring apparatus 102 includes the detection unit 103, the output unit 104, a display unit 105, an image storage unit 106, and a detection storage unit 107.

The detection unit 103 detects the person P taking a predetermined action, based on an image being acquired by imaging the inspection area R, which is included in the image information. Herein, the “action” include not only a moving state but also a still state.

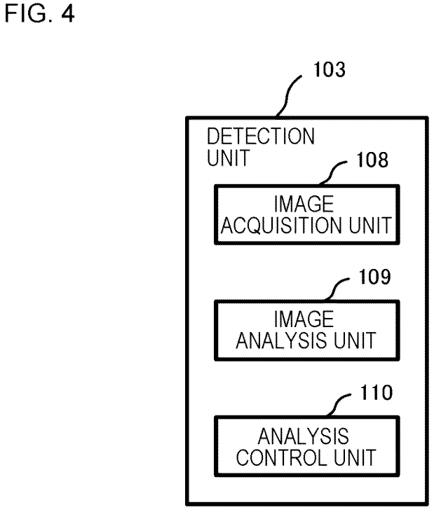

In detail, as illustrating a functional configuration example of the detection unit 103 in FIG. 4, the detection unit 103 includes an image acquisition unit 108, an image analysis unit 109, and an analysis control unit 110.

The image acquisition unit 108 acquires image information from the imaging apparatus 101 via the network N. The image acquisition unit 108 is capable of acquiring the image information including a video (moving image) from the imaging apparatus 101 in real time.

The image analysis unit 109 analyzes an image being acquired by imaging the inspection area R, which is included in the image information.

In detail, the image analysis unit 109 includes one or a plurality of analysis functions of executing processing for analyzing an image (analysis processing). The analysis processing executed by the analysis functions included in the image analysis unit 109 includes one or a plurality pieces of (1) object detection processing, (2) face analysis processing, (3) human shape analysis processing, (4) pose analysis processing, (5) action analysis processing, (6) external appearance attribute analysis processing, (7) gradient feature analysis processing, (8) color feature analysis processing, (9) flow line analysis processing, and the like.
(1) In the object detection processing, an object can be detected from an image. In the object detection processing, a position of an object in an image can also be acquired. An example of a model to be applied to the object detection processing includes you only look once (YOLO). In the object detection processing, for example, the person P, the luggage L, the smartphone SP, and the like can be detected.

Herein, the “object” includes a person and an item, and this applies similarly in the following description.
(2) In the face analysis processing, a face of a person can be detected from an image. In the face analysis processing, extraction of a feature value of the face being detected (face feature value), categorization (classification) of the face being detected, and the like can be executed. In face detection processing, a position of a face in an image can also be acquired. In the face detection processing, identity of a person being detected from different images can also be decided based on a similarity degree of the face feature values of the person being detected from the different images, or the like
(3) In the human shape analysis processing, extraction of a human body feature value (for example, a value indicating an overall feature such as a body shape such as obese or thin, a height, and clothes) of a person being included in an image, categorization (classification) of the person being included in the image, and the like are executed. In human shape feature detection processing, a position of a person in an image can also be determined. In the human shape feature detection processing, identity of a person being detected from different images can also be decided based on the human body feature value of the person being included in the different images, or the like.
(4) In the pose analysis processing, for example, a stick human model is built by detecting a joint point of a person from an image and connecting the joint points. Further, in the pose analysis processing, a pose of a person is estimated by using information relating to the stick human model, and extraction of a feature value of the pose being estimated (pose feature value), categorization (classification) of the person being included in the image, and the like can be executed. For example, in the pose analysis processing, identity of a person being detected from different images can also be decided based on the pose feature values of the person being included in the different images, or the like. In the pose analysis processing, for example, a pose such as a crouching pose, a squatting pose, a standing pose, and a calling pose is estimated from an image, and the pose feature value or the like is extracted. The calling pose is a pose of making a call by using a communication device such as the smartphone SP, and this applies similarly in the following description.

For example, a technique disclosed in Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291 to 7299 can be applied to the pose analysis processing.
(5) In the action analysis processing, a movement of a person is estimated by using information relating to a stick human model, a change of a pose, or the like, and extraction of a feature value of the movement of the person (movement feature value), categorization (classification) of the person being included in an image, and the like can be executed. In action detection processing, a height of a person can be estimated by using information relating to the stick human model, and a position of a person in an image can be determined.
(6) In the external appearance attribute analysis processing, an external appearance attribute associated with a person can be recognized. In the external appearance attribute analysis processing, extraction of a feature value relating to the external appearance attribute being recognized (external appearance attribute feature value), categorization (classification) of the person being included in an image, and the like can be executed. The external appearance attribute is an attribute relating to an external appearance, and includes, for example, one or more of a color of clothes, a color of a shoe, a hair style, a hat or a necktie, wearing of glasses, and the like.
(7) In the gradient feature analysis processing, a feature value of a gradient (gradient feature value) in an image can be acquired. For example, techniques such as SIFT, SURF, RIFF, ORB, BRISK, CARD, and HOG are applicable to gradient feature detection processing.
(8) In the color feature analysis processing, an object can be detected from an image. In the color feature analysis processing, extraction of a feature value of a color of the object being detected (color feature value), categorization (classification) of the object being detected, and the like can be executed. The color feature value is a color histogram or the like. In the color feature analysis processing, for example, when the person P, the luggage L, and the smartphone SP being included in an image is detected, those can be categorized into classes of the person P, the luggage L, and the smartphone SP.
(9) In the flow line analysis processing, for example, a flow line (a trajectory of a movement) of a person can be acquired by using a result regarding decision on identity of a person in any of the analysis processing (2) to (6) described above. Specifically, for example, the flow line of a person can be acquired by connecting the person being decided as the same person in different images in time series. In the flow line analysis processing, for example, it is also possible to acquire a flow line over a plurality of images being acquired by imaging different areas, such as images being acquired by imaging an adjacent area.

Note that, in each piece of the analysis processing (1) to (9), results of the other pieces of analysis processing may be used appropriately.

The analysis control unit 110 controls the image analysis unit 109, and acquires a result of the analysis by the image analysis unit 109. Further, the analysis control unit 110 detects the person P taking a predetermined action, based on the result of the analysis by the image analysis unit 109. The predetermined action includes one or more of a first action to a fourth action described below and the like.

The first action is an action being decided in relation to an item (for example, the luggage L and the smartphone SP) being included in an image being acquired by imaging the inspection area R. For example, the analysis control unit 110 detects the person P taking the first action by using the object detection processing, action detection processing, or the like.

The second action is an action being decided in relation to a visual line of the person P being included in an image being acquired by imaging the inspection area R. For example, the analysis control unit 110 detects the person P taking the second action by using face detection processing, the action detection processing (for example, orientation of a shoulder), or the like. In the face detection processing, for detection of the second action, a position and a movement of a face, particularly, an iris and a pupil (so-called, a darker part of an eye) may be detected, and feature values of those may be acquired.

The second action may be an action being decided in relation to a visual line with respect to one or both of a predetermined person and item such as a staff member in the inspection area R and an investigation dog. In this case, for the second action, the person P taking the second action may be detected by further using one or a plurality of the object detection processing, human shape feature detection processing, external appearance attribute detection processing, gradient feature detection processing, color feature detection processing, and the like.

The third action is an action being decided in relation to a movement of the person P being included in an image being acquired by imaging the inspection area R. Herein, the “movement” includes not only a movement that involves a change in position but also staying in a fixed location. For example, the analysis control unit 110 detects the person P taking the third action by using the flow line analysis processing or the like.

The third action may be an action being decided in relation to a movement with respect to one or both of a predetermined person and item such as a staff member in the inspection area R, an investigation dog, and the writing stand T. In this case, for detection of one or both of the predetermined person and item, the analysis control unit 110 may detect the person P taking the third action by further using one or a plurality of the object detection processing, the human shape feature detection processing, the external appearance attribute detection processing, the gradient feature detection processing, the color feature detection processing, and the like.

The fourth action is an action being decided in relation to entry in/exit from a predetermined area (for example, the inspection area R or a bathroom) by a person being included in an image being acquired by imaging the inspection area R. For example, the analysis control unit 110 detects the person P taking the fourth action by using the flow line analysis processing and the like.

For determination of an entrance/exit of the predetermined area, the analysis control unit 110 may detect the person P taking the fourth action by further using, for example, the object detection processing, the gradient feature detection processing, and the color feature detection processing. Alternatively, the analysis control unit 110 may hold information indicating a location of an entrance/exit of a bathroom or the like in advance, and may detect the person P taking the fourth action by further using the information.

Details of the first action to the fourth action are described later.

Further, the analysis control unit 110 may execute processing for tracking the person P being detected. In this case, for example, the analysis control unit 110 may acquire a flow line of the person P being detected by using the flow line analysis processing or the like.

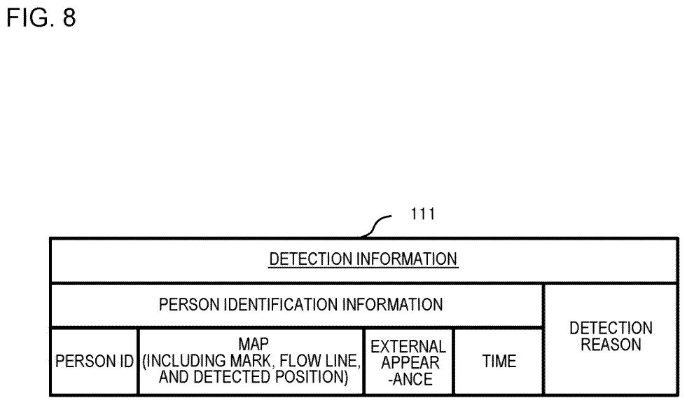

The output unit 104 outputs detection information (see FIG. 8) relating to the person P being detected by the analysis control unit 110.

For example, the detection information includes person determination information for determining the person P being detected.

The person determination information may be information indicating a position (for example, a current position) of the person P being detected. In this case, the person determination information may further include at least one of an image of the inspection area R, a map of the inspection area R, and the like, and may be information in which a mark indicating the person P being detected is given in at least one of the image, the map, and the like of the inspection area R. The image of the inspection area R included in the person determination information is preferably an image being acquired by imaging the inspection area R, more preferably, an image from which the person P being marked is detected.

The person determination information may include a result of tracking the person P being detected. In this case, the person determination information may further include the image of the inspection area R, the map of the inspection area R, and the like, and may be information in which the flow line of the person P being detected is indicated in the image, the map, and the like of the inspection area R. The image of the inspection area R included in the person determination information is preferably an image being acquired by imaging the inspection area R, more preferably, an image from which the person P with the line flow is detected, further more preferably, a latest image from which the person P with the line flow is detected.

The person determination information may be information indicating an external appearance (clothes, a hair style, and the like) of the person P being detected.

For example, the detection information may include a reason for which the person P being determined by using the person determination information is detected. The detection reason is information indicating a content of the predetermined action which causes the detection of the person P.

The display unit 105 displays various types of information. For example, the display unit 105 acquires the detection information from the output unit 104, and displays the detection information. Note that, the display unit 105 may be a terminal apparatus or the like (omitted in illustration) connected to the monitoring apparatus 102 via the network N and held by a staff member (in particular, the staff member may be a security guard) in the inspection area R.

The image storage unit 106 is a storage unit that stores an image being acquired by the detection unit 103 (the image acquisition unit 108).

The detection storage unit 107 is a storage unit that stores the detection information.

The functional configuration of the monitoring system 100 according to the first example embodiment is mainly described above. Hereinafter, a physical configuration of the monitoring system 100 according to the present example embodiment is described.

### <<Physical Configuration of the Monitoring System 100>>

In a physical sense, the monitoring system 100 is configured by the imaging apparatus 101 and the monitoring apparatus 102 that are connected to each other via the network N. Each of the imaging apparatus 101 and the monitoring apparatus 102 is configured by a single apparatus being different from each other in a physical sense.

Note that, in a physical sense, the monitoring apparatus 102 may be configured by a plurality of apparatuses that are connected to each other via an appropriate communication line such as the network N. The imaging apparatus 101 and the monitoring apparatus 102 may be configured by a single apparatus in a physical sense. For example, when the monitoring system 100 includes a plurality of the imaging apparatuses 101, one or a plurality of the imaging apparatuses 101 may include at least a part of the monitoring apparatus 102.

In a physical sense, for example, the monitoring apparatus 102 is a general-purpose computer.

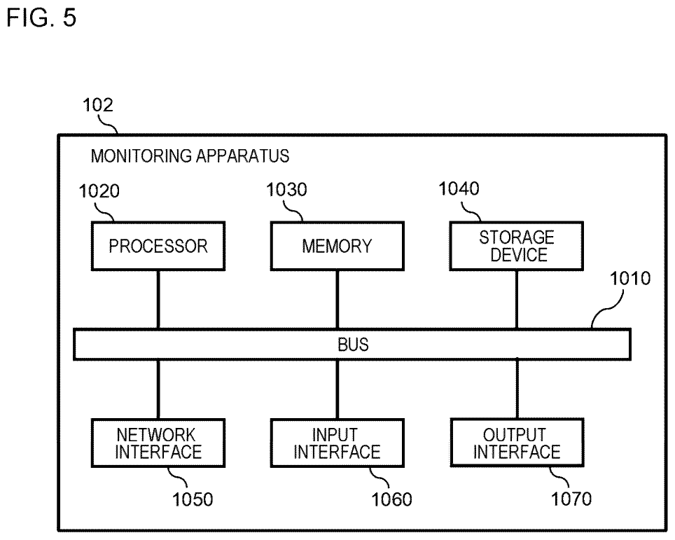

In detail, for example, as illustrated in FIG. 5, in a physical sense, the monitoring apparatus 102 includes a bus 1010, a processor 1020, a memory 1030, a storage device 1040, a network interface 1050, an input interface 1060, and an output interface 1070.

The bus 1010 is a data transmission path in which the processor 1020, the memory 1030, the storage device 1040, the network interface 1050, the input interface 1060, and the output interface 1070 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module achieving a function of the monitoring apparatus 102. The processor 1020 reads each of the program modules on the memory 1030 and executes the read program module, and thereby each of the functions associated with each of the program modules is achieved.

The network interface 1050 is an interface for connecting the monitoring apparatus 102 to the network N.

The input interface 1060 is a touch panel, a keyboard, a mouse, or the like being an interface for inputting information by a user.

The output interface 1070 is a liquid crystal panel, an organic electro-luminescence (EL) panel, or the like being an interface for providing information to a user. The output interface 1070 constitutes the display unit 105. Note that, the output interface 1070 may be incorporated into the monitoring apparatus 102, or may be provided outside of the monitoring apparatus 102.

The physical configuration of the monitoring system 100 according to the first example embodiment is mainly described above. Hereinafter, the operation of the monitoring system 100 according to the first example embodiment is described.

### (Operation of Monitoring System 100)

The monitoring apparatus 102 executes the monitoring processing (see FIG. 2). The monitoring processing is processing for monitoring the inspection area R. For example, when a start instruction is received from a user, the monitoring apparatus 102 starts the monitoring processing. For example, when a termination instruction is received from a user, the monitoring apparatus 102 terminates the monitoring processing.

Details of detection processing (step S101) and output processing (step S102) are described below. Description is made by using an example all the first action to the fourth action are detected.

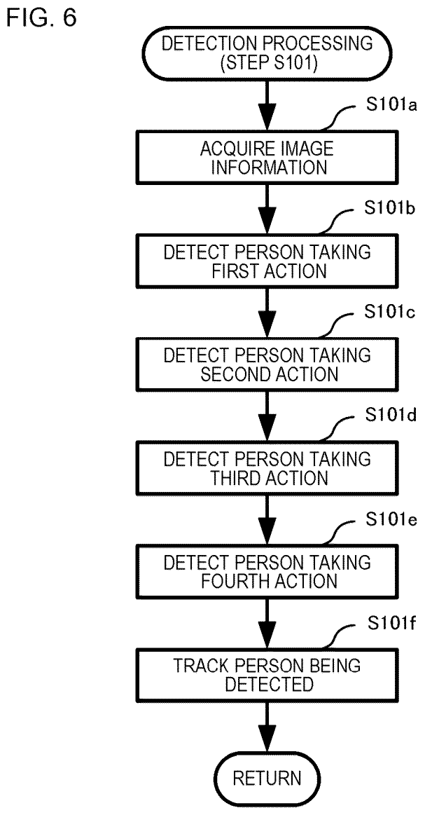

FIG. 6 is a flowchart illustrating an example of details of the detection processing (step S101) according to the present example embodiment.

The image acquisition unit 108 acquires image information from the imaging apparatus 101 (step S101a). The image acquisition unit 108 causes the image storage unit 106 to store the image information.

For detection of the person P taking the first action, the analysis control unit 110 causes the image analysis unit 109 to analyze an image being included in the image information being acquired in step S101a. As a result, the analysis control unit 110 detects the person P taking the first action being decided in relation to an item being included in an image, based on the image being acquired by imaging the inspection area R (step S101b).

For example, the item being decided in the first action is the luggage L and the smartphone SP. The smartphone SP is one example of a communication device being a device used for communication. The communication device is not limited to the smartphone SP, and may be a mobile phone, a head set, and the like. The head set is a device including a headphone or an ear phone, and a microphone.

### (Example of First Action)

For example, the first action may include being within a first range from the luggage L and in a first pose.

The first range is a range being decided appropriately in advance. For example, the first range may be a predetermined distance from the luggage L, a contact range with the luggage L, or the like. For example, the first range may be a predetermined distance from a specific part of the person P, such as a hand and a waist, a contact range with the specific part, or the like. Those distances may be defined as a distance (for example, 10 centimeters) in a real space, or may be defined as a distance (for example, 20 pixels) in an image. Further, the first range is not limited to a spherical shape, and may be decided as an appropriate shape.

The first pose is a pose being decided appropriately in advance, and is at least one of a crouching pose, a squatting pose, and the like. The crouching pose can be detected based on bending of a waist and a leg. The squatting pose can be detected based on detection that a leg is bent and a waist is lower than that in a standing state.

The first action may include being within the first pose from the luggage L and maintaining the first pose for a first time period or longer. The first time period is a time period being decided appropriately in advance, and is three minutes, for example.

In general, in the inspection area R, due to frequent congestion caused by arrival and departure of flights, the large number of persons P carrying the luggage L, and the like, it is sometimes difficult to detect opening and closing of the luggage L from an image. Further, relying solely on monitoring by human labor may cause overlooking. By detecting the person P taking the example of the first action described herein, it is possible to assist detection of the person P opening and closing the luggage L in the inspection area R.

### (Other Examples of First Action)

Further, for example, the first action may include being in a pose of making a call by using the smartphone SP or the like (calling pose). For example, the calling pose may be detected based on detection of a pose of an arm holding a communication device such as the smartphone SP closer to an ear or a mouth.

The first action may include maintaining the calling pose for a second time period or longer. The second time period is a time period being decided appropriately in advance, and is one minute, for example.

The first action may further include holding the smartphone SP within a second range from a face. The second range is a range being decided appropriately in advance. For example, the second range may be a predetermined distance from a face, a contact range with a face, or the like. The distance may be defined as a distance (for example, a few centimeters) in a real space, or may be defined as a distance (for example, 10 pixels) in an image. Further, the first range is not limited to a spherical shape, and may be decided as an appropriate shape.

Further, for example, the first action may include talking in the calling pose. For example, talking may be detected based on detection of a moving mouth by using the face detection processing. In this case, the first action may talking while the person P is not present in the periphery (in other words, within a predetermined range from the person P). Further, the first action may include talking for a predetermined time period or longer.

In general, in the inspection area R, due to frequent congestion caused by arrival and departure of flights, it is sometimes difficult to detect the person P making a call in the inspection area R. Further, relying solely on monitoring by human labor may cause overlooking. By detecting the person P taking other examples of the first action described herein, it is possible to assist detection of the person P making a call in the inspection area R.

For detection of the person P taking the second action, the analysis control unit 110 causes the image analysis unit 109 to analyze the image being included in the image information being acquired in step S101a. As a result, the analysis control unit 110 detects the person P taking the second action being decided in relation to a visual line of a person being included in an image, based on the image being acquired by imaging the inspection area R (step S101c).

### (Example of Second Action)

For example, the second action may include changing a visual line direction continuously for a third time period or longer, or intermittently at a first frequency or more. The third time period is a time period being decided appropriately in advance, and is, for example, 15 seconds or the like. The first frequency is a frequency being decided appropriately in advance, and is, for example, twice in 10 seconds, or the like. Further, the second action may include changing the visual line direction intermittently at the first frequency or more for a predetermined time period or longer.

In general, in the inspection area R, due to frequent congestion caused by arrival and departure of flights, it is sometimes difficult to detect the person P who is restless and frequently moves the visual line in the inspection area R. Further, relying solely on monitoring by human labor may cause overlooking. By detecting the person P taking the example of the second action described herein, it is possible to assist detection of the person P who is restless and frequently moves the visual line in the inspection area R.

### (Other Examples of Second Action)

Further, for example, an action relating to a visual line with respect to a predetermined target may be included. The second action may include gazing at the predetermined target continuously for a fourth time period or longer, or intermittently at a second frequency or more.

The predetermined target herein may be one or both of a person and an item, and is, for example, a staff member in the inspection area R (in particular, may be a security guard), an investigation dog, and the like.

A staff member, an investigation dog, and the like often wear predetermined uniforms and have designated equipment. In such a case, the analysis control unit 110 is capable of detecting the predetermined target such as a staff member and an investigation dog while distinguishing them from another person P and item by using one or a plurality of the object detection processing, the external appearance attribute detection processing, the color feature detection processing, and the like.

Note that, when the predetermined target such as a staff member and an investigation dog carries a device (omitted in illustration) that transmits information for determining the position, the analysis control unit 110 may determine the position of the predetermined target, based on the information from the device. Further, the analysis control unit 110 may detect the predetermined target from an image by using the position.

The fourth time period is a time period being decided appropriately in advance, and is, for example, 15 seconds or the like. The second frequency is a frequency being decided appropriately in advance, and is, for example, three times in 15 seconds, or the like. Further, the second action may include gazing at the predetermined target intermittently at the first frequency or more for a predetermined time period or longer.

In general, in the inspection area R, due to frequent congestion caused by arrival and departure of flights, it is sometimes difficult to detect the person P who is concerned about the predetermined target while gazing at the target. Further, relying solely on monitoring by human labor may cause overlooking. By detecting the person P taking other examples of the second action described herein, it is possible to assist detection of the person P who is concerned about the predetermined target.

For detection of the person P taking the third action, the analysis control unit 110 causes the image analysis unit 109 to analyze the image being included in the image information being acquired in step S101a. As a result, the analysis control unit 110 detects the person P taking the third action being decided in relation to a movement of a person being included in an image, based on the image being acquired by imaging the inspection area R (step S101d).

### (Example of Third Action)

For example, the third action may include staying in a first area for a fifth time period or longer. The third action may include staying in the first area for the fifth time period or longer. The third action may include staying in a constant pose in the first area for the fifth time period or longer.

Staying indicates stopping at a certain point, moving within a certain area, or the like. For example, the first area is a predetermined area from a reference location, the inspection area R, or the like. For example, the reference location is a location where the person P is present at a certain time point, or a location where the writing stand T is provided. The fifth time period is a time period being decided appropriately in advance, and may be decided appropriately according to the first area. The constant pose is at least one of a crouching pose, a squatting pose, and the like.

In general, in the inspection area R, due to frequent congestion caused by arrival and departure of flights, it is sometimes difficult to detect the person P staying in the first area, such as the inspection area R, a certain location within the inspection area R, and the periphery of the writing stand T, for a long time period. Further, it is sometimes difficult to detect the person P being in the constant pose during the staying period. Relying solely on monitoring by human labor may cause overlooking. By detecting the person P taking the example of the third action described herein, it is possible to assist detection of the person P staying in the first area for a long time period or the person P being in the constant pose during the staying period.

### (Other Examples of Third Action)

Further, for example, the third action may include an action of avoiding a predetermined target by a person being included in an image being acquired by imaging the inspection area R. As escribed above, the predetermined target may be one or both of a person and an item, and is, for example, a staff member in the inspection area R (in particular, the staff member may be a security guard), an investigation dog, and the like.

For example, the action of avoiding is an action of reversing a movement direction within a third range from the predetermined target. The third range is a range being decided appropriately in advance. For example, the third range is a range within a predetermined distance. The distance may be defined as a distance (for example, one to two meters) in a real space, or may be defined as a distance (for example, 100 to 200 pixels) in an image. Further, the first range is not limited to a spherical shape, and may be decided as an appropriate shape. By detecting the person P taking the action of avoiding described above, the person P who sees the predetermined target and then turns back can be detected.

Further, for example, the action of avoiding is an action of changing a moving direction in such a way as to move outside a fourth range when a prediction position based on the movement direction of the person P falls within the fourth range from the predetermined target. The fourth range is a range being decided appropriately in advance. The distance may be defined as a distance (for example, one to two meters) in a real space, or may be defined as a distance (for example, 100 to 200 pixels) in an image. Further, the first range is not limited to a spherical shape, and may be decided as an appropriate shape. By detecting the person P taking the action of avoiding described above, the person P moving away from the predetermined target can be detected.

In general, in the inspection area R, due to frequent congestion caused by arrival and departure of flights, it is sometimes difficult to detect the person P avoiding the predetermined target such as a staff member and an investigation dog in the inspection area R. Further, relying solely on monitoring by human labor may cause overlooking. By detecting the person P taking other examples of the third action described herein, it is possible to assist detection of the person P avoiding the predetermined target.

For detection of the person P taking the fourth action, the analysis control unit 110 causes the image analysis unit 109 to analyze the image being included in the image information being acquired in step S101a. As a result, the analysis control unit 110 detects the person P taking the fourth action being decided in relation to entry in/exit from a predetermined area by a person being included in an image, based on the image being acquired by imaging the inspection area R (step S101e).

The predetermined area in the fourth action may be an area being decided appropriately in advance, and is, for example, a bathroom in the inspection area R. The predetermined area may be the inspection area R or the like.

### (Example of Fourth Action)

For example, the fourth action may include a case in which a person being included in an image being acquired by imaging the inspection area R does not leave the predetermined area after a sixth time period or longer is elapsed from entry in the predetermined area. The sixth time period is a time period being decided appropriately in advance, and is, for example, three minutes to five minutes.

In general, in the inspection area R, due to frequent congestion caused by arrival and departure of flights, it is sometimes difficult to detect the person P staying in the predetermined area such as a bathroom in the inspection area R for a long time period. Further, relying solely on monitoring by human labor may cause overlooking. By detecting the person P taking the example of the fourth action described herein, it is possible to assist detection of the person P staying in the predetermined area for a long time period.

### (Other Examples of Fourth Action)

Further, for example, the fourth action may include an action of changing an external appearance in the predetermined area by a person being included in an image being acquired by imaging the inspection area R. For example, the external appearance is clothes, belongings, and the like of the person P.

In this case, for example, the analysis control unit 110 may detect, as a person taking the action of changing the external appearance, the person P whose external appearance at a time of exiting from the predetermined area is changed from that at a time of entering the predetermined area.

In detail, the analysis control unit 110 holds a face feature value and information (for example, an external appearance attribute feature value, a human shape feature value, an object being detected) relating to an external appearance of the person P when entering the predetermined area. When the person P with the matching face feature value exits from the predetermined area, the analysis control unit 110 compares the external appearance of the person P being included in the information being held with the external appearance of the person P exiting from the predetermined area.

As a result of the comparison, when the external appearances do not match with each other, the analysis control unit 110 may decide that the external appearance of the person P is changed, and may detect the person P as a person P taking the action of changing the external appearance. As a result of the comparison, when the external appearances match with each other, the analysis control unit 110 may decide that the external appearance of the person P is not changed, and may not detect the person P as a person P taking the action of changing the external appearance.

Herein, “matching” means a substantially matching state. In other words, “matching” includes not only being completely identical but also being different within a predetermined range.

More specifically, for example, when a change in clothes in a bathroom is detected, the analysis control unit 110 holds a face feature value and information (for example, an external appearance attribute feature value, a human shape feature value) relating to clothes of the person P when entering the bathroom. The analysis control unit 110 acquires the face feature value and information relating to clothes of the person P exiting from the bathroom.

The analysis control unit 110 compares the face feature values between the person P entering the bathroom and the person P exiting from the bathroom. As a result of the comparison, the analysis control unit 110 decides the identity of the person P. Further, with regard to the person P being decided as the same person, when the information relating to the clothes at the time of entry in the bathroom and that at the time of exit from the bathroom do not match with each other, the analysis control unit 110 detects that the clothes is changed in the bathroom.

Further, for example, when a change of the luggage L in a bathroom is detected, the analysis control unit 110 holds a face feature value and information (for example, a detection result of the object detection processing, an external appearance attribute feature value, a human shape feature value) relating to the luggage L of the person P when entering the bathroom. The analysis control unit 110 acquires the face feature value and information relating to the luggage L of the person P exiting from the bathroom.

The analysis control unit 110 compares at least one of the face feature values, the external appearance attribute feature values, and the human shape feature values between the person P entering the bathroom and the person P exiting from the bathroom. As a result of the comparison, the analysis control unit 110 decides the identity of the person P. Further, with regard to the person P being decided as the same person, when the information relating to the luggage L at the time of entry in the bathroom and that at the time of exit from the bathroom do not match with each other, the analysis control unit 110 detects that the luggage L is changed in the bathroom.

Normally, it can be estimated that the person P whose external appearance at the time of exiting from the predetermined area is changed from that at the time of entering the predetermined area takes the action of changing the external appearance in the predetermined area. Thus, by detecting the person P whose external appearance at the time of exiting from the predetermined area is changed from that at the time of entering the predetermined area, the person P taking the action of changing the external appearance in the predetermined area can be detected.

Further, for example, the analysis control unit 110 may hold entry information relating to the person P entering the predetermined area. Further, the analysis control unit 110 may detect, as a person P taking the action of changing the external appearance, the person P not being included in the entry information among the persons P leaving the predetermined area.

The person P not being included in the entry information among the persons P leaving the predetermined area can be estimated as a person P whose external appearance at a time of leaving the predetermined area is changed from that at a time of entry therein to such an extent that the person P cannot be decided as the same person from an image. Thus, by detecting the person P not being included in the entry information among the persons P leaving the predetermined area, the person P taking the action of changing the external appearance in the predetermined area can be detected.

In general, in the inspection area R, due to frequent congestion caused by arrival and departure of flights, it is sometimes difficult to detect the person P whose external appearance is changed in the predetermined area. Further, relying solely on monitoring by human labor may cause overlooking. In particular, when the external appearance is changed to such an extent that the person P cannot be decided as the same person from an image, the change is highly likely to be overlooked. By detecting the person P taking other examples of the fourth action described herein, it is possible to assist detection of the person P taking the action of changing the external appearance in the predetermined area.

The analysis control unit 110 executes processing for tracking the person P being detected in at least one of steps S101b to S101e (step S101f).

In detail, the analysis control unit 110 provides a person ID for identifying the person P to each of the persons P included in the image. For the person P being detected in at least one of steps S101b to S101e, the analysis control unit 110 holds tracking information for tracking the person P. For example, the tracking information includes at least one of the person ID and an image feature value (for example, a face feature value) to be used for tracking of the person P being detected.

Further, the analysis control unit 110 decides whether the image being included in the image information being acquired in step S101a includes the person P being detected, based on the tracking information. When the analysis control unit 110 decides that the person P being detected is included, the analysis control unit 110 causes the image analysis unit 109 to generate a flow line of the person P being detected by using the flow line analysis processing, for example, and stores the flow line in association with the person ID in the tracking information. With this, even when any of the first action to the fourth action is terminated, after the detection in at least one of step S101b to step S101e, the analysis control unit 110 can execute tracking by using the flow line of the person P being detected.

When step S101f is executed, the analysis control unit 110 terminates the detection processing (step S101), and returns to the monitoring processing (see FIG. 2).

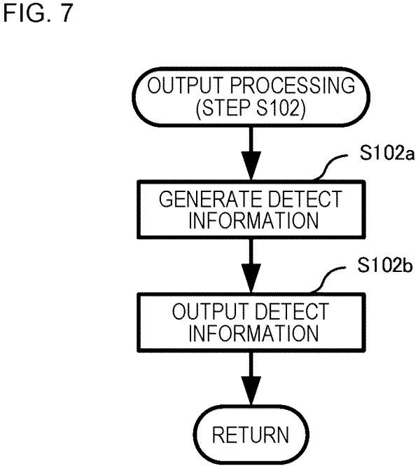

FIG. 7 is a flowchart illustrating a detailed example of the output processing (step S102) according to the present example embodiment. The output unit 104 generates detection information 111 relating to the person P being detected in at least one of steps S101b to S101e, based on a result of executing steps S101b to S101f by the analysis control unit 110 (step S102a). The output unit 104 causes the detection storage unit 107 to store the detection information.

FIG. 8 is a diagram illustrating one example of a configuration of the detection information 111. The detection information 111 is information in which the person determination information for determining the person P being detected and a reason for which the person P is detected are associated with each other. The person determination information includes the person ID of the person P, a map and an external appearance of the inspection area R, and a time. The map includes a mark indicating a position of the person P at the time being associated therewith. Further, the map includes a flow line of the person P from the detection of the person P to a time of association. The map includes a position at which the person P is detected.

The output unit 104 outputs the detection information 111 being generated in step S102a (step S102b). In the present example embodiment, the output unit 104 outputs the detection information 111 to the display unit 105, and causes the display unit 105 to display the detection information 111.

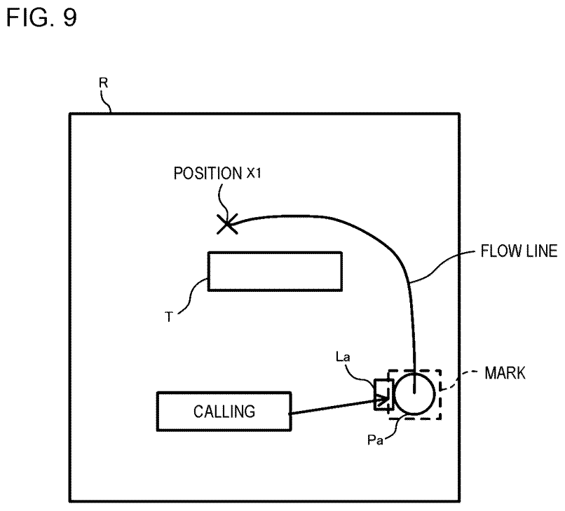

FIG. 9 is a diagram illustrating one example of the detection information 111 being displayed by the display unit 105. In the example in FIG. 3, it is an example in which the person Pa present at a position of X1 is detected because of being present in the calling pose using the smartphone SP, and then moves. This drawing illustrates an example in which the detection information 111 includes a floor plan of the inspection area R (a map of the inspection area R as viewed from above) and the mark indicating the position of the person P, the flow line, and the detection reason are indicated and overlaid the floor plan.

The flow line indicates a trajectory of the movement of the person Pa. FIG. 9 illustrates an example in which, as the mark indicating the position of the person Pa (for example, a current position), a square dot-line surrounding the person P is given. FIG. 9 illustrates an example in which “calling” being the reason for which the person Pa is detected is associated with an image of the person Pa (in the example in FIG. 9, the mark indicating the position of the person Pa).

The detection information 111 includes the mark indicating the position of the person Pa, and thus a user can easily recognize the position of the person Pa by using the display unit 105. Further, tracking of the person Pa by visual observation is facilitated by recognizing the position of the person Pa. Therefore, it is possible to assist monitoring in the inspection area R effectively.

The detection information 111 includes the flow line, and thus a user can easily recognize the flow line of the person Pa by using the display unit 105. Therefore, it is possible to assist monitoring in the inspection area R effectively.

The detection information 111 includes the detection reason, and thus a user can easily recognize the reason for which the person Pa is detected, by using the display unit 105. Therefore, it is possible to assist monitoring in the inspection area R effectively.

The detection information 111 includes images before and after the change of the external appearance of the person P, and thus a user can browse the images before and after the change of the external appearance by using the display unit 105. With this, a user can easily recognize a face feature of the person P, and can easily find the person P in the inspection area R. Therefore, it is possible to assist monitoring in the inspection area R effectively. Herein, the images before and after the change of the external appearance of the person P may be any of a moving image and a still image including the person P.

Note that, the mark indicating the position of the person P is not limited thereto, and a shape of the mark may be changed appropriately. Further, as the mark, the output unit 104 may use an area of the person P in the image in a flashing manner. Further, the display unit may always or temporarily display the detection reason.

An example of temporal display may include a case in which display is performed for a predetermined time period when a cursor hovers over the area displaying the person Pa in response to an operation of a user, hovering of a cursor and clicking are performed, or the like. Further, another example of the temporal display may include a case in which display is performed for a time period during which a cursor hovers over the area displaying the person Pa in response to an operation of a user. Moreover, a different example of the temporal display may include a case in which display is performed for a predetermined time period after tapping the area when a touch panel is provided to the display unit 105.

When step S102b is executed, the output unit 104 terminates the output processing (step S102), and returns to the monitoring processing (see FIG. 2). Further, the detection unit 103 executes step S101 again.

The first example embodiment of the present invention is described above.

According to the present example embodiment, the monitoring apparatus 102 includes the detection unit 103 and the output unit 104. The detection unit 103 detects a person taking a predetermined action, based on an image being acquired by imaging the inspection area R. The output unit 104 outputs detection information relating to the person being detected.

In this manner, the monitoring apparatus 102 processes the image being acquired by imaging the inspection area R, and detects the person P taking the predetermined action, and hence the person P who requires attention can be detected rapidly and appropriately. Therefore, it is possible to assist monitoring in the inspection area R effectively.

According to the present example embodiment, the predetermined action includes the first action to the fourth action described above. When the predetermined action includes each of the first action to the fourth action, an image being acquired by imaging the inspection area R can be processed and thereby detect the person P, based on the action being generally taken by a person who requires attention, and the person P who requires attention can be detected rapidly and appropriately. Therefore, when the predetermined action includes each of the first action to the fourth action, it is possible to assist monitoring in the inspection area R effectively. When the predetermined action includes a plurality of actions among the first action to the fourth action, it is possible to assist monitoring in the inspection area R more effectively. Moreover, as in the present example embodiment, the predetermined action includes all of the first action to the fourth action, and thus it is possible to assist monitoring in the inspection area R further more effectively.

### First Modification Example

Information being included in the detection information 111 is not limited to the information described in the first example embodiment. The detection information 111 may include a detection time and the like in addition to the information illustrated in FIG. 8, and may include some pieces thereof.

Further, with regard to the person P for which the fourth action is detected, the detection information 111 may include images (for example, images of a face, images of the whole body) imaged at a time of entry in a predetermined area and exit from the predetermined area. In other words, with regard to the person P taking the action of changing an external appearance, the detection information 111 may include images before and after the change of the external appearance of the person P.

When the detection information 111 includes the images before and after the change of the external appearance of the person P, the images may be images of a front of the person P. For this reason, the monitoring system 100 may include the plurality of imaging apparatuses 101 that are installed an entrance/exit of the predetermined area in such a way that the person P entering and exiting from the area can be imaged from the front. Further, when a plurality of entrances/exits are provided in the predetermined area, the monitoring system 100 may include one or a plurality of imaging apparatuses 101 for imaging each of the entrances/exits.

The detection information 111 includes the images before and after the change of the external appearance of the person P, and thus a user can browse the images before and after the change of the external appearance by using the display unit 105. With this, a user can easily recognize a face feature of the person P. Therefore, it is possible to assist monitoring in the inspection area R effectively.

### Second Modification Example

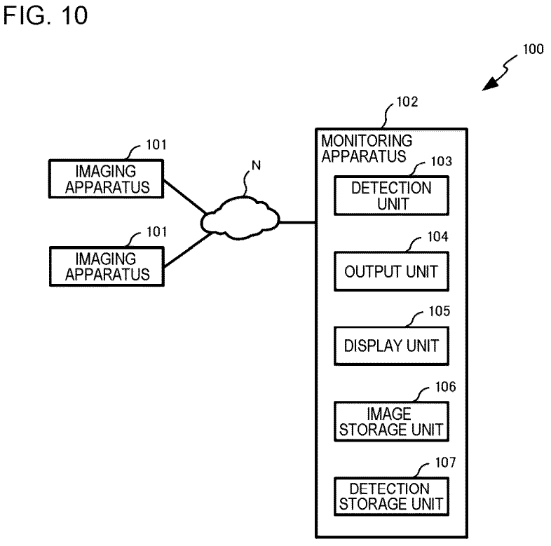

FIG. 10 is a diagram illustrating a configuration example of a monitoring system 100 according to a second modification example. The monitoring system 100 according to the present modification example includes a plurality of imaging apparatuses 101 similar to the imaging apparatus 101 according to the first example embodiment. Except for this point, the monitoring system 100 according to the present modification example may be configured similarly to the monitoring system 100 according to the first example embodiment. In other words, FIG. 10 illustrates an example in which the monitoring system 100 includes the plurality of imaging apparatuses 101.

When the monitoring system 100 includes the plurality of imaging apparatuses 101, the monitoring apparatus 102 may also include functions similar to those in the first example embodiment, and may execute similar processing. In the present modification example, an advantageous effect similar to that in the first example embodiment can also be achieved.

### Second Example Embodiment

In the first example embodiment, the analysis control unit 110 decides (collates) whether all persons P being indicated by the person IDs and the like that are included in tracking information are included in an image being included in image information.

Thus, in the analysis control unit 110, when the number of person IDs being included in the tracking information becomes large, a processing load of the analysis control unit 110 for tracking the persons P is increased.

Herein, in general, the person P who leaves an inspection area R does not return to the inspection area R. Thus, there is little need for executing the processing for tracking (step S101f) for the person P who leaves the inspection area R. In a second example embodiment, description is made on an example in which an analysis control unit 110 is not caused to execute processing for tracking (step S101f) for the person P who leaves the inspection area R. In the present example embodiment, for the sake of simplification of the description, a different point from the first example embodiment is mainly described, and the description overlapping with the first example embodiment is omitted appropriately.

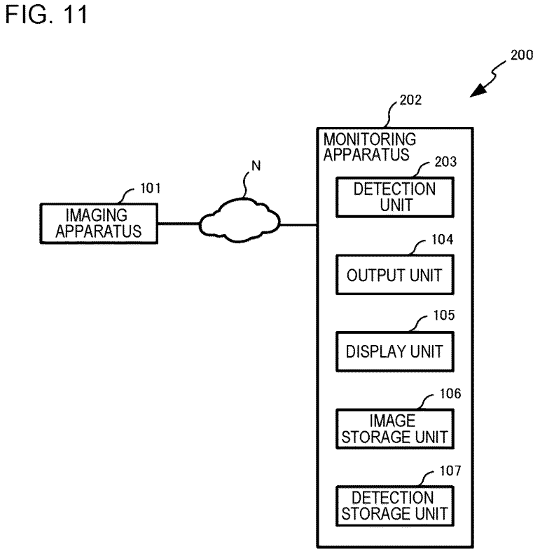

FIG. 11 is a diagram illustrating a configuration example of a monitoring system 200 according to the second example embodiment of the present invention.

The monitoring system 200 the monitoring system 200 according to the present example embodiment includes a monitoring apparatus 202 in place of the monitoring apparatus 102 according to the first example embodiment. Except for this point, the monitoring system 200 according to the present example embodiment may be configured similarly to the monitoring system 100 according to the first example embodiment.

The monitoring apparatus 202 includes a detection unit 203 in place of the detection unit 103 according to the first example embodiment. Except for this point, the monitoring apparatus 202 according to the present example embodiment may be configured similarly to the monitoring apparatus 102 according to the first example embodiment.

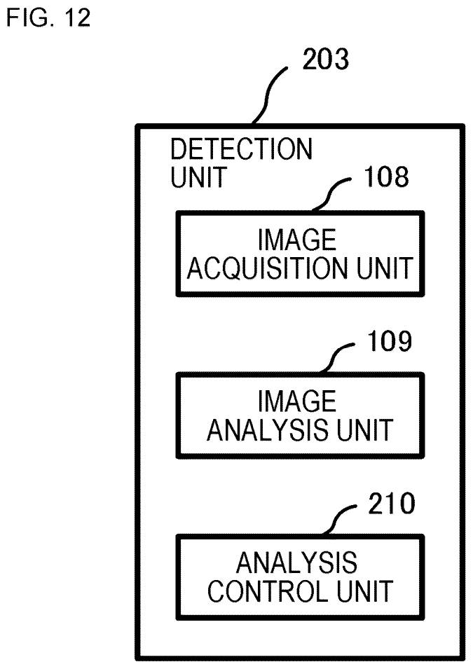

As a functional configuration example of the detection unit 203 is illustrated in FIG. 12, the detection unit 203 includes an analysis control unit 210 in place of the analysis control unit 110 of the first example embodiment. Except for this point, the detection unit 203 according to the present example embodiment may be configured similarly to the detection unit 103 according to the first example embodiment.

The analysis control unit 210 detects that the person P being detected leaves the inspection area R, by using an image analysis unit 109. When it is detected that the person P being detected leaves the inspection area R, the analysis control unit 210 deletes information (tracking information) for tracking the person P who leaves the inspection area R. Except for this point, the analysis control unit 210 according to the present example embodiment may be configured similarly to the analysis control unit 110 according to the first example embodiment.

The monitoring system 200 according to the present example embodiment may be configured similarly to the monitoring system 100 according to the first example embodiment in a physical sense.

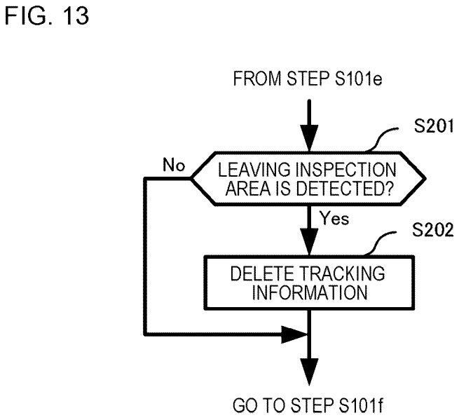

FIG. 13 is a flowchart illustrating one example of detection processing according to the present example embodiment. FIG. 13 only illustrates matters relating to the detection processing according to the present example embodiment that are different from the detection processing (step S101) according to the first example embodiment. As illustrated in this drawing, monitoring processing according to the present example embodiment includes steps S201 and 202 between steps S101e and S101f. Except for this point, the monitoring processing according to the present example embodiment may be similar to the monitoring processing according to the first example embodiment.

When step S101e is executed, the analysis control unit 210 decides whether the person P being detected leaves the inspection area R, based on tracking information being held in the own unit (step S201). When not leaving the inspection area R is decided (step S201: No), the analysis control unit 210 executes step S101f.

When leaving the inspection area R is decided (step S201: Yes), the analysis control unit 210 deletes the tracking information for tracking the person P who leaves the inspection area R (step S202).

Subsequently, the analysis control unit 210 executes tracking processing (step S101f).

In the detection processing according to the present example embodiment, in step S202 before executing the tracking processing (step S101f), the tracking information relating to the person P who leaves the inspection area R can be deleted. Thus, the analysis control unit 110 can be caused not to execute the processing for tracking the person P (step S101f).

The second example embodiment of the present invention is described above.

According to the present example embodiment, when it is detected that the person P being detected leaves the inspection area R, the detection unit 203 (the analysis control unit 210) deletes information for tracking the person P. With this, as described above, after the person P being detected leaves the inspection area R, the analysis control unit 110 can be caused not to substantially execute the processing for tracking the person P (step S101f).

In the detection processing according to the present example embodiment, the analysis control unit 210 holds the tracking information while the person P is present in the inspection area R, and hence the person P being detected can be tracked by using the tracking information. Meanwhile, after the person P being detected leaves the inspection area R, it is extremely difficult for the analysis control unit 110 to execute the processing for tracking the person P (step S101f). Thus, as compared to a case in which the tracking information relating to the person P is held even after the person P being detected leaves the inspection area R, a processing load of the analysis control unit 110 can be reduced. In other words, the processing load for tracking the person P being detected can be reduced while achieving tracking of the person P being detected. Therefore, it is possible to assist monitoring in the inspection area R effectively while reducing the processing load of the monitoring apparatus 202.

### Third Example Embodiment

In the first example embodiment, description is made on an example in which one or a plurality of analysis functions are included, and those pieces of analysis processing are executed at all times. However, the image analysis unit 109 may include a plurality of analysis functions, and may switch which one of those pieces of the analysis processing for analyzing an image being acquired by imaging an inspection area R. In the present example embodiment, for the sake of simplification of the description, a different point from the first example embodiment is mainly described, and the description overlapping with the first example embodiment is omitted appropriately.

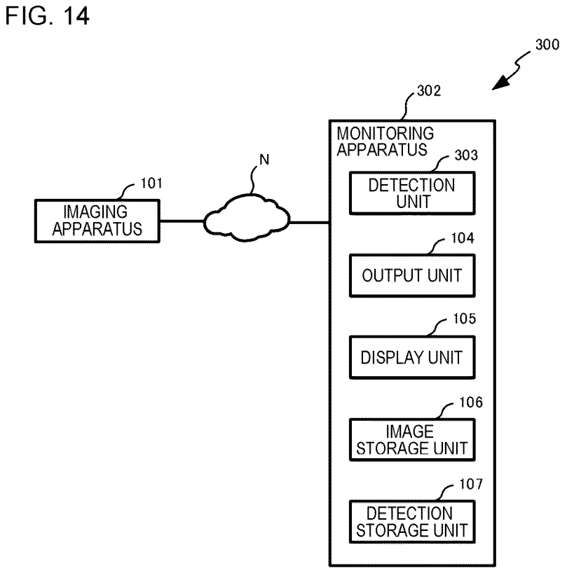

FIG. 14 is a diagram illustrating a configuration example of a monitoring system 300 according to a third example embodiment of the present invention.

The monitoring system 300 the monitoring system 300 according to the present example embodiment includes a monitoring apparatus 302 in place of the monitoring apparatus 102 according to the first example embodiment. Except for this point, the monitoring system 300 according to the present example embodiment may be configured similarly to the monitoring system 100 according to the first example embodiment.

The monitoring apparatus 302 includes a detection unit 303 in place of the detection unit 103 according to the first example embodiment. Except for this point, the monitoring apparatus 302 according to the present example embodiment may be configured similarly to the monitoring apparatus 102 according to the first example embodiment.

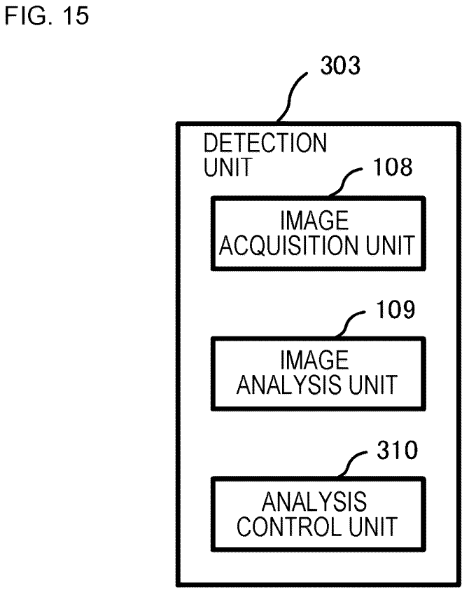

As a functional configuration example of the detection unit 303 is illustrated in FIG. 15, the detection unit 303 includes an analysis control unit 310 in place of the analysis control unit 110 of the first example embodiment. Except for this point, the detection unit 303 according to the present example embodiment may be configured similarly to the detection unit 103 according to the first example embodiment.

The analysis control unit 310 switches which one of the plurality of pieces of the analysis processing for processing an image being acquired by imaging the inspection area R is used for processing the image being acquired by imaging the inspection area R, according to a situation of the inspection area R.

In detail, the analysis control unit 310 switches the analysis processing to be used for processing an image being acquired by imaging the inspection area R, according to whether the situation of the inspection area R satisfies a predetermined criterion.

As described above, the analysis processing is one or more of (1) object detection processing, (2) face analysis processing, (3) human shape feature analysis processing, (4) pose analysis processing, (5) action analysis processing, (6) external appearance attribute analysis processing, (7) gradient feature analysis processing, (8) color feature analysis processing, (9) flow line analysis processing, and the like.

For example, the situation of the inspection area R is a congestion level of the inspection area R. The congestion level includes an overall congestion level of the inspection area R, a local congestion level of a part of the inspection area R, and the like. For example, the overall congestion level is the total number of persons P present in the inspection area R. For example, the local congestion level is density of an area being particularly crowded with the persons P in the inspection area R, the number of persons P present in a predetermined area (for example, a predetermined range from a writing stand T) in the inspection area R, and the like.

For example, the predetermined criterion is that the congestion level is less than a predetermined threshold value. For example, when the congestion level is equal to or greater than the threshold value, the analysis control unit 310 processes an image being acquired by imaging the inspection area R by using all the plurality of pieces of the analysis processing. For example, when the congestion level is less than the threshold value, the analysis control unit 310 processes an image being acquired by imaging the inspection area R by using some of the plurality of pieces of the analysis processing.

In this case, for example, the analysis control unit 310 compares the congestion level of the inspection area R and a threshold value TH with each other, and controls which of the plurality of pieces of the analysis processing for processing an image being acquired by imaging the inspection area R is used for processing the image being acquired by imaging the inspection area R, based on a comparison result.

The monitoring system 300 according to the present example embodiment may be configured similarly to the monitoring system 100 according to the first example embodiment in a physical sense.

The monitoring apparatus 302 according to the present example embodiment executes monitoring processing including detection processing (step S301) in place of the detection processing (S101) according to the first example embodiment. Except for this point, the monitoring processing according to the present example embodiment may be similar to the monitoring processing according to the first example embodiment.

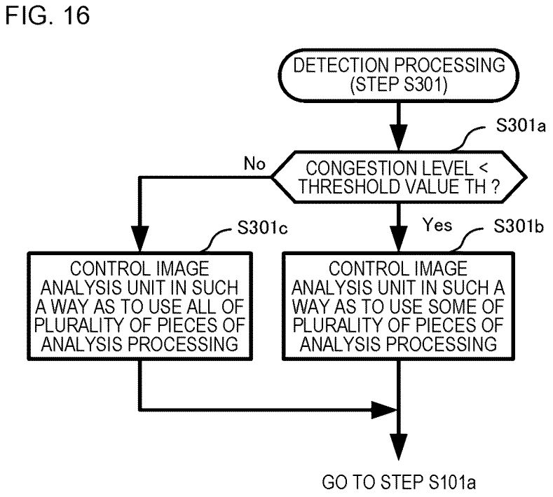

FIG. 16 is a flowchart illustrating one example of the detection processing (S301) according to the present example embodiment. FIG. 16 only illustrates matters relating to the detection processing according to the present example embodiment that are different from the detection processing (step S101) according to the first example embodiment. As illustrated in this drawing, the detection processing (S301) according to the present example embodiment includes steps S301a to S301c before step S101a. Except for this point, the detection processing (S301) according to the present example embodiment may be similar to the detection processing (S101) according to the first example embodiment.

In this drawing, an example of a flowchart in which the situation of the inspection area R is the congestion level is illustrated. Further, an example of a flowchart in which the predetermined criterion is less than the predetermined threshold value relating to the congestion level is illustrated.

The analysis control unit 310 decides whether the congestion level is less than the predetermined threshold value TH (step S301a).

When it is decided that the congestion level is less than the threshold value TH (step S301a: Yes), the analysis control unit 310 controls an image analysis unit 109 in such a way as to use some of the plurality of pieces of the analysis processing to be executed by the image analysis unit 109 (step S301b).

As a result of executing step S301b, the image analysis unit 109 analyzes an image being acquired by imaging the inspection area R, by using some of the plurality of pieces of the analysis processing. Herein, which analysis processing among the plurality of pieces of the analysis processing is used may be decided appropriately.

Note that, in other words, the plurality of pieces of the analysis processing to be executed by the image analysis unit 109 are the plurality of analysis functions included in the image analysis unit 109.

When it is decided that the congestion level is not less than the threshold value TH (step S301a: No), the analysis control unit 310 controls the image analysis unit 109 in such a way as to use all the plurality of pieces of the analysis processing to be executed by the image analysis unit 109 (step S301c).

The analysis control unit 310 executes step S301b or S301c, and then executes the processing from step S101a onwards according to the first example embodiment.

In the present example embodiment, before executing the processing from step S101a onwards, the analysis control unit 310 executes step S301b or S301c according to a situation of the inspection area R, and switches the analysis processing to be used for processing an image being acquired by imaging the inspection area R.

In the example of the present example embodiment, when the congestion level is less than the threshold value TH, the analysis processing to be used for processing an image being acquired by imaging the inspection area R can be reduced as compared to a case in which the congestion level is equal to or greater than the threshold value TH.

When the congestion level is low, visual recognition in the inspection area R is more feasible, and hence it is possible to assist monitoring in the inspection area R even when accuracy of the analysis processing is relatively low. When the congestion level is high, visual recognition in the inspection area R is less feasible, and hence the analysis processing with high accuracy is expected. Further, a processing load of the monitoring apparatus 302 can be reduced by reducing the analysis processing to be used for processing an image being acquired by imaging the inspection area R.

In this manner, according to the detection processing (S301) according to the present example embodiment, it is possible to assist monitoring in the inspection area R effectively while reducing the processing load of the monitoring apparatus 302.

The third example embodiment of the present invention es described above.

According to the present example embodiment, the detection unit 303 (the analysis control unit 310) switches which of the plurality of pieces of the analysis processing for processing an image being acquired by imaging the inspection area R is used for processing the image being acquired by imaging the inspection area R, according to a situation of the inspection area R.

With this, as described above, accuracy of the analysis processing being required according to the situation of the inspection area R can be maintained while reducing a processing load of the monitoring apparatus 302. Therefore, it is possible to assist monitoring in the inspection area R effectively while reducing the processing load of the monitoring apparatus 302.

### Third Modification Example

For example, in the third example embodiment, the analysis control unit 310 may acquire aviation information including at least one of an arrival time and departure time of a flight. For example, the analysis control unit 310 may acquire the aviation information, based on an input from a user, or acquire from an external apparatus (omitted in illustration).

Further, the analysis control unit 310 may switch which of a plurality of pieces of the analysis processing for processing an image being acquired by imaging the inspection area R is used for processing the image being acquired by imaging the inspection area R, based on the aviation information.

In detail, for example, the analysis control unit 310 may predict a situation of the inspection area R (for example, a congestion level), based on the aviation information. In this case, the analysis control unit 310 may switch which of the plurality of pieces of the analysis processing for processing an image being acquired by imaging the inspection area R is used for processing the image being acquired by imaging the inspection area R, based on a prediction result.

In this example, the analysis control unit 310 can also switch which of the plurality of pieces of the analysis processing for processing an image being acquired by imaging the inspection area R is used for processing the image being acquired by imaging the inspection area R, according to the situation of the inspection area R.

Further, for example, the analysis control unit 310 may switch which of the plurality of pieces of the analysis processing for processing an image being acquired by imaging the inspection area R is used for processing the image being acquired by imaging the inspection area R, based on whether to be a predetermined time from a time included in the aviation information. In general, the inspection area R is congested according to arrival and departure of flights.

Thus, in this example, the analysis control unit 310 can also switch which of the plurality of pieces of the analysis processing for processing an image being acquired by imaging the inspection area R is used for processing the image being acquired by imaging the inspection area R, according to the situation of the inspection area R.

In the present modification example, the detection unit 303 (the analysis control unit 310) can also switch which of the plurality of pieces of the analysis processing for processing an image being acquired by imaging the inspection area R is used for processing the image being acquired by imaging the inspection area R, according to the situation of the inspection area R. Therefore, an advantageous effect similar to that in the third example embodiment can be achieved.

While the example embodiments and the modification examples of the present invention are described above with reference to the drawings, those are examples of the present invention, and various configurations other than those described above may be adopted.

Further, in a plurality of flowcharts used in the description given above, a plurality of steps (pieces of processing) are described in order, but the execution order of the steps executed in each of the example embodiments is not limited to the described order. In each of the example embodiments, the order of the illustrated steps can be changed without interfering with the contents. Further, the example embodiments and the modification examples described above can be combined with each other within a range where the contents do not conflict with each other.

The whole or a part of the example embodiments described above can be described as, but not limited to, the following supplementary notes.
1. A monitoring apparatus including:
   a detection unit that detects a person taking a predetermined action, based on an image being acquired by imaging an inspection area; and
   an output unit that outputs detection information relating to the person being detected.
2. The monitoring apparatus according to supplementary note 1, wherein
   the predetermined action includes a first action being decided in relation to an item included in the image.
3. The monitoring apparatus according to supplementary note 2, wherein
   the item is luggage, and
   the first action includes being within a first range from the luggage and in a first pose.
4. The monitoring apparatus according to supplementary note 3, wherein
   the first range from the luggage is a contact range with the luggage.
5. The monitoring apparatus according to supplementary note 3 or 4, wherein
   the first pose is at least one of a squatting pose, and a crouching pose.
6. The monitoring apparatus according to any one of supplementary notes 3 to 5, wherein
   the first action includes maintaining the first pose for a first time period or longer.
7. The monitoring apparatus according to any one of supplementary notes 2 to 6, wherein
   the item is a communication tool, and
   the first action includes maintaining a pose of making a call by using the communication tool.
8. The monitoring apparatus according to supplementary note 7, wherein
   the first action includes maintaining the pose of making a call for a second time period or longer.
9. The monitoring apparatus according to supplementary note 7 or 8, wherein
   the first action includes holding the communication tool within a second range from a face.
10. The monitoring apparatus according to supplementary note 9, wherein
   the second range from the face is a contact range with the face.
11. The monitoring apparatus according to any one of supplementary notes 7 to 10, wherein
   the first action includes talking.
12. The monitoring apparatus according to any one of supplementary notes 1 to 11, wherein
   the predetermined action includes a second action being decided in relation to a visual line of a person being included in the image.
13. The monitoring apparatus according to supplementary note 12, wherein
   the second action includes changing a visual line direction continuously for a third time period or longer, or intermittently at a first frequency or more.
14. The monitoring apparatus according to supplementary note 12 or 13, wherein
   the second action includes an action relating to a visual line with respect to a predetermined target.
15. The monitoring apparatus according to supplementary note 14, wherein
   the second action includes gazing at the predetermined target continuously for a fourth time period or longer, or intermittently at a second frequency or more.
16. The monitoring apparatus according to any one of supplementary notes 1 to 15, wherein
   the predetermined action includes a third action being decided in relation to a movement of a person being included in the image.
17. The monitoring apparatus according to supplementary note 16, wherein
   the third action includes staying in a first area for a fifth time period or longer.
18. The monitoring apparatus according to supplementary note 17, wherein
   the first area is a predetermined range from the inspection area or a reference location.
19. The monitoring apparatus according to supplementary note 17 or 18, wherein
   The third action includes staying in a constant pose in the first area for the fifth time period or longer.
20. The monitoring apparatus according to any one of supplementary notes 16 to 19, wherein
   the third action includes an action of avoiding a predetermined target by a person being included in the image.
21. The monitoring apparatus according to supplementary note 20, wherein
   the action of avoiding includes at least one of an action of reversing a movement direction within a third range from the predetermined target, and an action of changing a moving direction in such a way as to move outside a fourth range when a prediction position based on a movement direction of a person falls within the fourth range from the predetermined target.
22. The monitoring apparatus according to any one of supplementary notes 1 to 21, wherein
   the predetermined action includes a fourth action being decided in relation to entry in/exit from a predetermined area by a person being included in the image.
23. The monitoring apparatus according to supplementary note 22, wherein
   the fourth action includes a case in which a person being included in the image does not leave the predetermined area after a sixth time period or longer is elapsed from entry in the predetermined area.
24. The monitoring apparatus according to supplementary note 22 or 23, wherein
   the fourth action includes an action of changing an external appearance in the predetermined area by a person being included in the image.
25. The monitoring apparatus according to supplementary note 24, wherein
   the detection unit detects, as a person taking the action of changing the external appearance, a person whose external appearance at a time of exiting from the predetermined area is changed from that at a time of entering the predetermined area.
26. The monitoring apparatus according to supplementary note 24 or 25, wherein
   the detection unit holds entry information relating to a person entering the predetermined area, and detects, as a person taking the action of changing the external appearance, a person not being included in the entry information among persons exiting from the predetermined area.
27. The monitoring apparatus according to any one of supplementary notes 24 to 26, wherein
   the detection information includes images of the person before and after change of an external appearance with regard to a person taking an action of changing the external appearance.
28. The monitoring apparatus according to any one of supplementary notes 1 to 27, wherein
   the detection unit further executes processing for tracking the person being detected, and
   the detection information includes a result of tracking the person being detected.
29. The monitoring apparatus according to any one of supplementary notes 1 to 28, wherein,
   when it is detected that the person being detected exits from the inspection area, the detection unit deletes information for tracking a person exiting from the inspection area.
30. The monitoring apparatus according to any one of supplementary notes 1 to 29, wherein
   the detection unit switches which of a plurality of pieces of analysis processing for processing the image is used for processing the image, according to a situation of the inspection area.
31. A monitoring system including:
   the monitoring apparatus according to any one of supplementary notes 1 to 30; and
   an imaging apparatus that generates image information including an image of the inspection area according to imaging the inspection area.
32. A monitoring method including,
   by a computer:
      detecting a person taking a predetermined action, based on an image being acquired by imaging an inspection area; and
      outputting detection information relating to the person being detected.
33. A program for causing a computer to execute:
   detecting a person taking a predetermined action, based on an image being acquired by imaging an inspection area; and
   outputting detection information relating to the person being detected

### REFERENCE SIGNS LIST

100, 200, 300 Monitoring system
101 Imaging apparatus
102, 202, 302 Monitoring apparatus
103, 203, 303 Detection unit
104 Output unit
105 Display unit
106 Image storage unit
107 Detection storage unit
108 Image acquisition unit
109 Image analysis unit
110, 210, 310 Analysis control unit
111 Detection information
P, Pa, Pb, Pc Person
L, La, Lb, Lc Luggage
R Inspection area
SP Smartphone
T Writing stand

What is claimed is:

1. A monitoring apparatus comprising:
at least one memory configured to store instructions; and
at least one processor configured to execute the instructions to perform operations comprising:
detecting a person taking a predetermined action, based on an image being acquired by imaging an inspection area; and
outputting detection information relating to the person being detected.

2. The monitoring apparatus according to claim 1, wherein
the predetermined action includes a first action being decided in relation to an item included in the image.

3. The monitoring apparatus according to claim 2, wherein
the item is luggage, and
the first action includes being within a first range from the luggage and in a first pose.

4. The monitoring apparatus according to claim 3, wherein
the first range from the luggage is a contact range with the luggage.

5. The monitoring apparatus according to claim 3, wherein
the first pose is at least one of a squatting pose, and a crouching pose.

6. The monitoring apparatus according to claim 3, wherein
the first action includes maintaining the first pose for a first time period or longer.

7. The monitoring apparatus according to claim 2, wherein
the item is a communication tool, and
the first action includes maintaining a pose of making a call by using the communication tool.

8. The monitoring apparatus according to claim 7, wherein
the first action includes maintaining the pose of making a call for a second time period or longer.

9. The monitoring apparatus according to claim 7, wherein
the first action includes holding the communication tool within a second range from a face.

10. The monitoring apparatus according to claim 9, wherein
the second range from the face is a contact range with the face.

11. The monitoring apparatus according to claim 7, wherein
the first action includes talking.

12. The monitoring apparatus according to claim 1, wherein
the predetermined action includes a second action being decided in relation to a visual line of a person being included in the image.

13. The monitoring apparatus according to claim 12, wherein
the second action includes changing a visual line direction continuously for a third time period or longer, or intermittently at a first frequency or more.

14. The monitoring apparatus according to claim 12, wherein
the second action includes an action relating to a visual line with respect to a predetermined target.

15. The monitoring apparatus according to claim 14, wherein
the second action includes gazing at the predetermined target continuously for a fourth time period or longer, or intermittently at a second frequency or more.

16. The monitoring apparatus according to claim 1, wherein
the predetermined action includes a third action being decided in relation to a movement of a person being included in the image.

17. The monitoring apparatus according to claim 16, wherein
the third action includes staying in a first area for a fifth time period or longer.

18. The monitoring apparatus according to claim 17, wherein
the first area is a predetermined range from the inspection area or a reference location.

19.-31. (canceled)

32. A monitoring method comprising,
by a computer:
detecting a person taking a predetermined action, based on an image being acquired by imaging an inspection area; and
outputting detection information relating to the person being detected.

33. A non-transitory computer readable medium storing a program for causing a computer to execute:
detecting a person taking a predetermined action, based on an image being acquired by imaging an inspection area; and
outputting detection information relating to the person being detected.
